(19) United States
(12) Patent Application Publication
(10) Pub. No.: US 2014/0115370 A1
(43) Pub. Date: Apr. 24, 2014

(54) ELECTRONIC DEVICE AND METHOD FOR REDUCING ENERGY CONSUMPTION OF STORAGE DEVICES

(71) Applicants: Hon Hai Precision Industry Co., Ltd., New Taipei (TW); Hong Fu Jin Precision Industry (ShenZhen) Co., Ltd., Shenzhen (CN)

(72) Inventors: DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/014,500

(22) Filed: Aug. 30, 2013

(30) Foreign Application Priority Data
Oct. 18, 2012 (CN) 2012103966611

(51) Int. Cl. G06F 1/32

(52) U.S. Cl. CPC G06F 1/3287; G06F 1/3268
USPC 713/324

(57) ABSTRACT

In a method for reducing energy consumption of storage devices in an electronic device, a directory index of files stored in the storage devices is established, and the storage devices are turned off after establishing the directory index. In response to receiving a user request for processing a target file, the method determines a target storage device that stores the target file when the directory index includes information of the target file. The target storage device is turned on, and the user request is transmitted to the target storage device. The target file is processed in the target storage device according to the user request.

### BACKGROUND

1. Technical Field

Embodiments of the present disclosure relate to power management technology, and particularly to an electronic device and method for reducing energy consumption of storage devices using the electronic device.

2. Description of Related Art

For large data storage, more and more storage devices (e.g., hard disk drives) are configured in an electronic device (e.g., a computer and a server). However, some of the storage devices may be idle for a long time, thus, the power consumption of the storage devices are wasted. Therefore, an efficient method for reducing energy consumption of the storage devices is desired.

### BRIEF DESCRIPTION OF THE DRAWINGS

FIG. 1 is a block diagram of a first embodiment of an electronic device including a management system.

FIG. 2 is a block diagram of a second embodiment of the electronic device including the management system.

FIG. 3 is a block diagram of one embodiment of power supplies in connection to storage devices of the electronic device.

FIG. 4 is a block diagram of one embodiment of switches in connection to the storage devices of the electronic device.

FIG. 5 is a block diagram of function modules of the management system.

FIG. 6 is a flowchart of one embodiment of a method for reducing energy consumption of the storage devices using the management system.

FIG. 7 is a flowchart of one embodiment of step S16 in FIG. 6.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

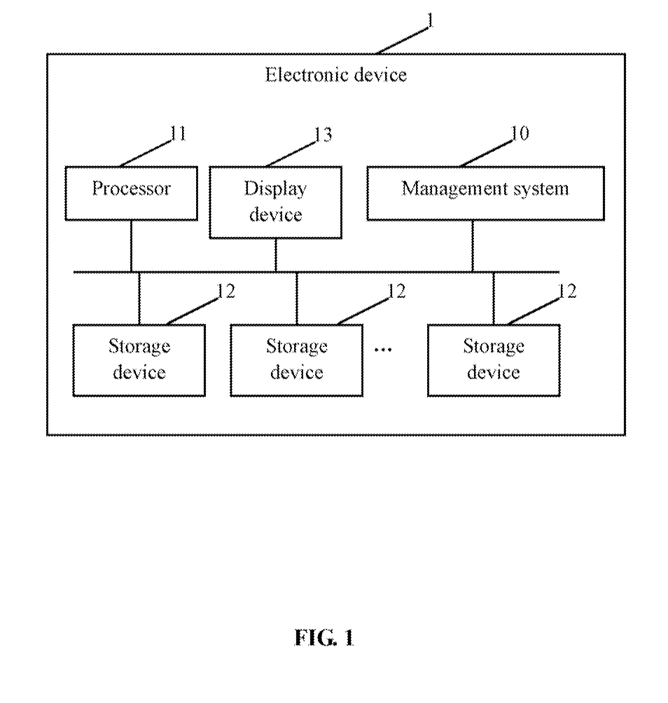

FIG. 1 is a block diagram of a first embodiment of an electronic device 1 including a management system 10. In some embodiments, the electronic device 1 may be a computer, a server, a test machine, a tablet computer, a personal digital assistant, a notebook computer, a mobile phone, or any other computing device. The electronic device 1 includes a plurality of storage devices 12 for storing data, such as files, images, videos, for example. In some embodiments, the storage devices 12 may be hard disks, or an external storage card, such as a memory stick, a smart media card, a compact flash card, a secure digital card, or any other type of memory storage device.

The management system 10 reduces energy consumption of the storage devices 12 by turning off one or more storage devices 12 when they are idle for a predetermined duration, and turning on one or more target storage devices when files stored in the target storage devices need to be processed or accessed, therefore saving power consumption of the storage devices 12.

The electronic device 1 further includes at least one processor 11 and a display device 13. The at least one processor 11 is used to execute the management system 10 and other applications installed in the electronic device 1, such as an operating system of the electronic device 1. The storage devices 12 store one or more programs, such as the operating system and applications of the electronic device 1.

In the first embodiment, the storage devices 12 are installed inside of the electronic device 1.

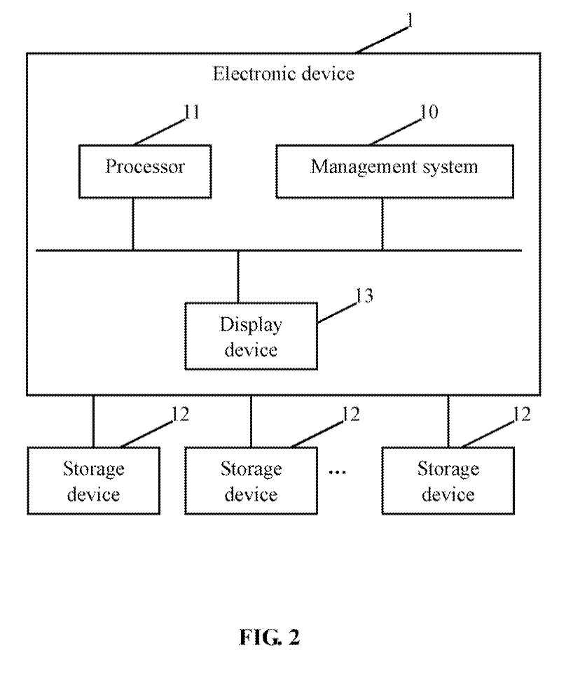

FIG. 2 is a block diagram of a second embodiment of the electronic device including the management system. In the second embodiment, the storage devices 12 are outside of the electronic device 1, and connected to the electronic device 1.

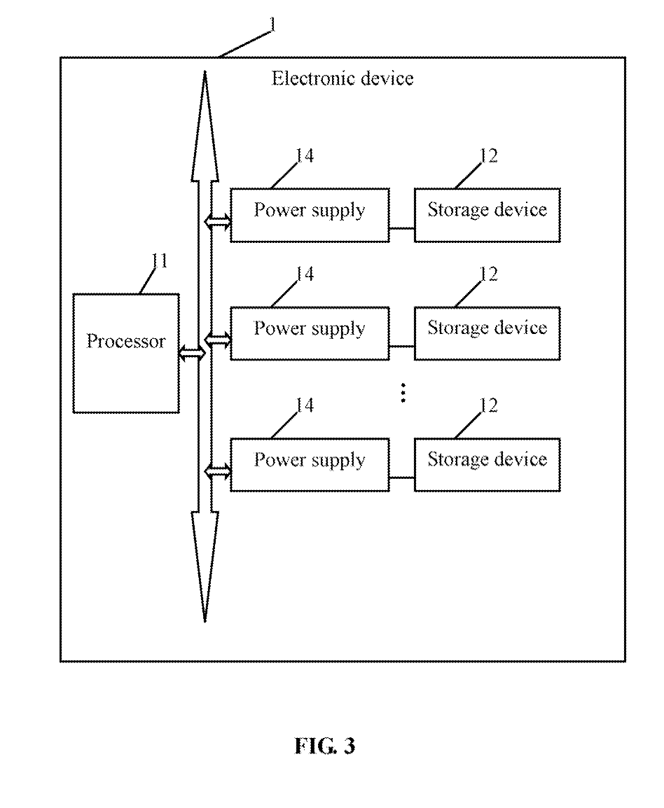

In some embodiments (not limited in the above two embodiments), as shown in FIG. 3, each of the storage devices 12 is connected to a single power supply 14, and the management system 10 reduces the energy consumption of each of the storage devices 12 by turning on or turning off a corresponding power supply 14.

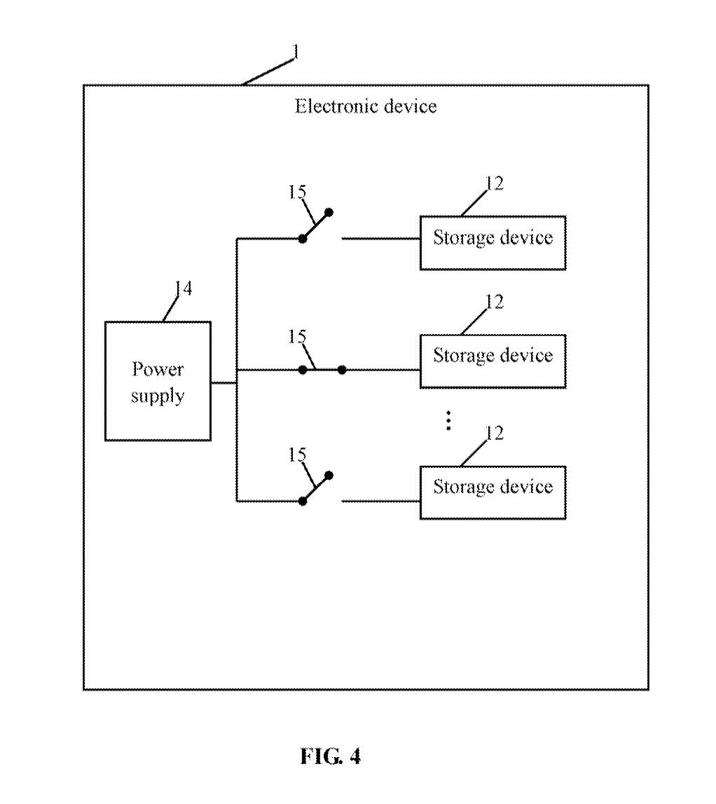

In other embodiments, as shown in FIG. 4, each of the storage devices 12 is connected to a switch 15, and the management system 10 reduces the energy consumption of each of the storage devices 12 by controlling the switch 15 of each of the storage devices 12. For example, when the management system 10 controls one switch 15 to connect a storage device 12 to the power supply 14, the storage device 12 is turned on (powered on), and a user may access or process data stored in the storage device 12. When the management system 10 controls the switch 15 to disconnect the storage device 12 from the power supply 14, the storage device 12 is turned off (powered off).

FIG. 1 and FIG. 2 illustrates only one example of the electronic device 1 that may include more or fewer components than illustrated, or have a different configuration of the various components.

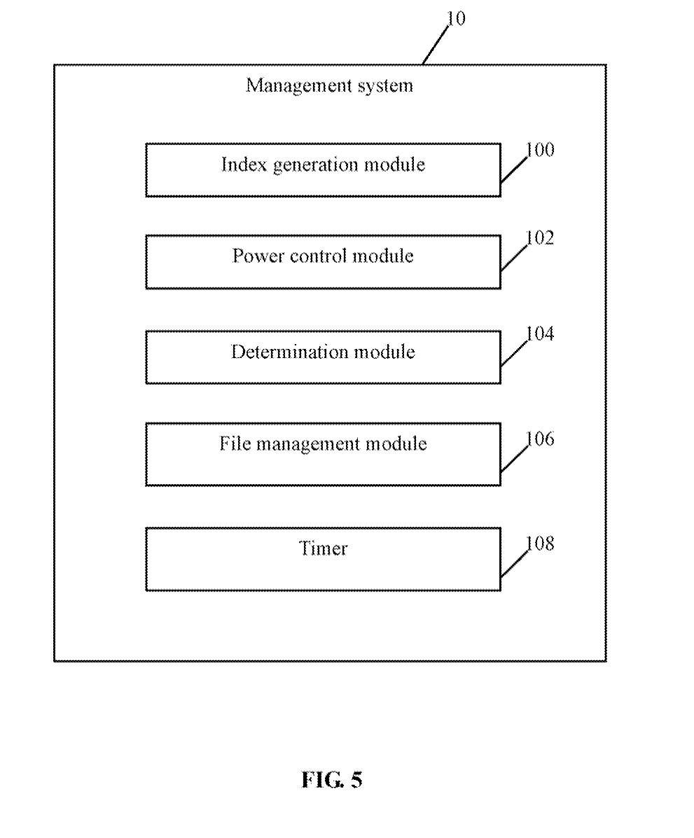

FIG. 5 is a block diagram of function modules of the management system 10. The management system 10 may include computerized instructions in the form of one or more programs that are executed by the at least one processor 11 and stored in one or more of the storage devices 12. In one embodiment, the management system 10 may include one or more modules, for example, an index generation module 100, a power control module 102, a determination module 104, a file management module 106, and a timer 108. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

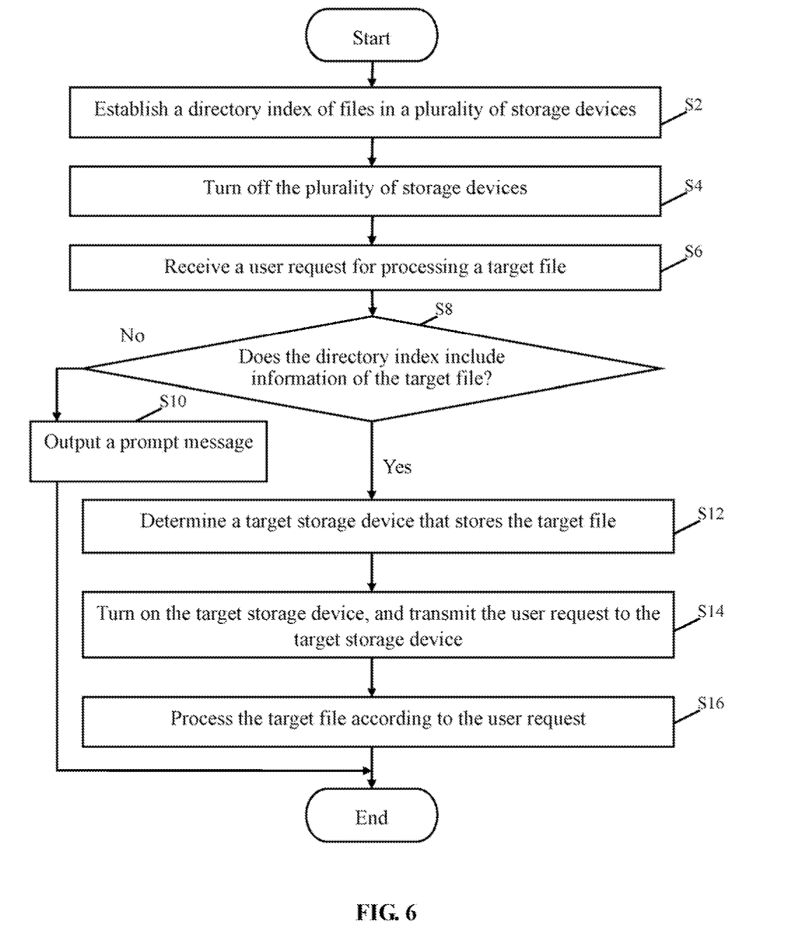

FIG. 6 is a flowchart of one embodiment of a method for reducing energy consumption of storage devices 12 using the management system 10. Depending on the embodiment, additional steps may be added, others removed, and the ordering of the steps may be changed.

In step S2, the index generation module 100 establishes a directory index of the files in the plurality of storage devices 12, and stores the directory index in one of the storage devices 12 or in a memory of the electronic device 1. For example, the index generation module 100 stores the directory index in a specified storage device. The specified storage device may be predetermined from the storage devices 12, and is enabled when the electronic device 1 is powered on, so that the user of the electronic device 1 may search files through the directory index in the specified storage device.

The directory index may include, but is not limited to file names and storage paths of the files, such as, “C:\folder\user,” for example.

In some embodiments, the index generation module 100 establishes the directory index for all of the files in the storage devices 12, or establishes a specific directory index for specific files in the storage devices 12. The specific files may have predetermined content or be in predetermined forms, such as image files having JPG format, for example.

In step S4, the power control module 102 turn off the storage devices 12. In a first embodiment, when the index generation module 100 finishes storing the directory index, the power control module 102 turns off the storage devices 12 to reduce the energy consumption of the storage devices 12.

In a second embodiments, when the directory index is finished storing, the power control module 102 does not turn off the storage devices 12 until the electronic device 1 is powered off. That is, the storage devices 12 are turned off when the electronic device 1 is powered off, and then when the electronic device 1 is restarted (e.g., is powered on the next time), the power control module 102 controls the storage devices 12 not to turn on. That is, the power control module 102 controls the power supplies 14 not to supply power to the storage devices 12, or controls the switches 15 to disconnect the storage devices 12 from the power supplies 14.

In other embodiments, one or more storage devices 12 may be predetermined to be the specified storage devices that are always powered on with the electronic device 1, to provide necessary data for the user. That is, the power supplies 14 or the switches 15 of the specified storage devices 21 are not shut down by the power control module 102.

In step S6, the determination module 104 receives a user request for processing a target file, such as accessing the target file, modifying the target file, copying the target file, or deleting the target file, for example. The user request for processing the target file may include, but is not limited to a file name. The user request may be inputted through an inputting device (e.g., a physical keyboard or a virtual keyboard) of the electronic device 1. The user request may be received by the determination module 104 from other electronic devices through a network (e.g., the Internet or WIFI) or a data connection (e.g., a data cable).

In step S8, the determination module 104 determines whether the directory index includes information of the target file. When the directory index does not include the information of the target file, step S10 is executed. When the directory index includes the information of the target file, step S12 is executed.

In step S10, the determination module 104 outputs a prompt message to indicate that the target file is not stored in the storage devices 12, and then the procedure ends. In other embodiments, the determination module 104 further prompts the user to input a new user request.

In step S12, the determination module 104 determines a target storage device that stores the target file. The determination module 104 may determine a storage path of the target file that records in the directory index, and then determine the target storage device according to the determined storage path. For example, a name of the target storage device is “A.”

In step S14, the power control module 102 turns on the target storage device, and transmit the user request to the target storage device.

In step S16, the file management module 106 processes the target file according to the user request, such as opens the target file, modifies the target file, saves the target file, deletes the target file, or copies the target file, for example.

In other embodiments, if the user request is for accessing a folder of a required storage device, the determination module 104 determines that the user request is for accessing a directory of the required storage device, but not for accessing files in the required storage device directly. The determination module 104 further determines whether the directory index includes information of files stored in the folder of the required storage device. When the directory index includes information of the files stored in the folder of the required storage device, the determination module 104 presents the directory of the folder in the required storage device by displaying the file information of the files stored in the folder of required storage device, on the display device 13. For example, the user request is for accessing a folder B in a storage device “A,” such as “A:\B,” the determination module 104 presents file information of files in the folder B of the storage device A.

Depending on the above embodiments, when the user needs to process a file in a storage device 12 that is powered off, the management system 10 may determine the storage device 12 to be the target storage device when information of the file is recorded in the directory index, and then turn on the target storage device by controlling a power supply 14 of the target storage device or connecting the target storage device to the poser supply 14 using a corresponding switch 15. In addition, when the user needs to access a folder of a storage device 12, the management system 10 determines that the user needs to access a directory of the folder, and presents the directory of the folder in the storage device 12 without turning on the storage device 12.

In other embodiments, the timer 108 calculates idle time of the target storage device. When the idle time is equal to a predetermined time duration (e.g., 5 minutes), the file management module 106 stores the target file and closes the target file, and the power control module 102 turns off the target storage device.

For example, the timer 108 starts to time the idle time when the target storage device receives the user request, and is reset when the target storage device receives a new user request. When the idle time is equal to the predetermined time duration and no new user request is received, as mentioned above, the power control module 102 turns off the target storage device after storing the target file, and the timer 108 stops working until another storage device receives user requests. The management system 10 may have a plurality of timers 108 to time idle time of multiple target storage devices synchronously.

In other embodiments, the timer 108 starts to time the idle time after the target storage device finishes processing the target file according to the user request.

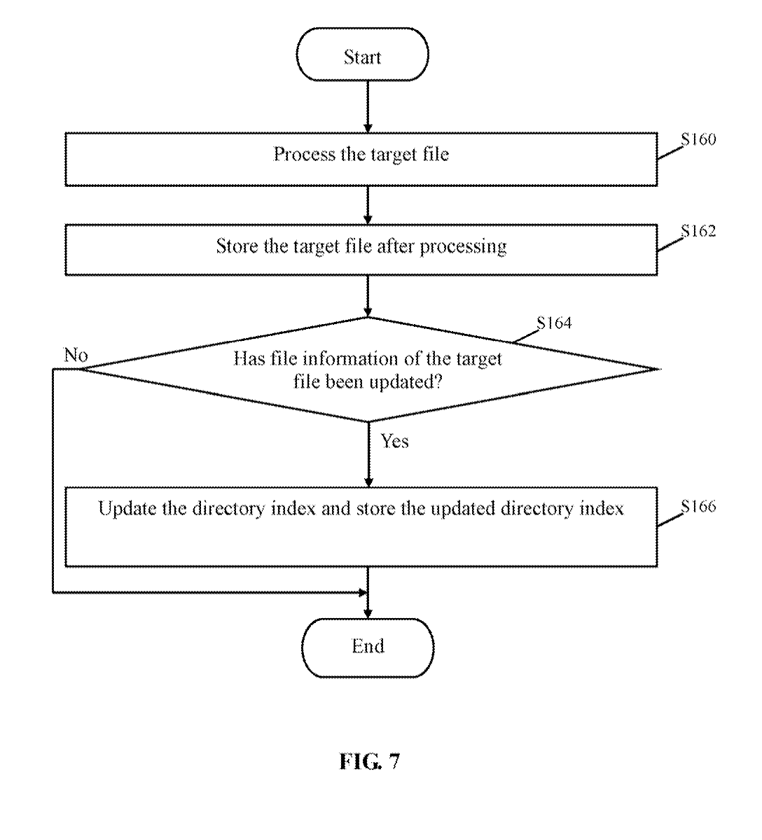

FIG. 7 is a flowchart of one embodiment of step S16 in FIG. 6. Depending on the embodiment, additional steps may be added, others removed, and the ordering of the steps may be changed.

In step S160, the file management module 106 processes the target file according to the user request.

In step S162, the file management module 106 stores the target file after processing.

In step S164, the index generation module 100 determines whether file information of the target file has been updated. For example, the file information of the target file may include a file name, a storage path, and file properties, for example. When the file information of the target file has been updated, step S166 is executed. When the file information of the target file has not been updated, the procedure ends.

In step S166, the index generation module 100 updates the directory index according to the updated file information, and stores the updated directory index.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for reducing energy consumption of a plurality of storage devices in an electronic device, the electronic device comprising a processor, the method comprising:
establishing a directory index of files stored in the plurality of storage devices;
turning off the plurality of storage devices using the processor;
in response to receiving a user request for processing a target file, determining whether the directory index comprises information of the target file;
determining a target storage device that stores the target file when the directory index comprises the information of the target file;
turning on the target storage device, and transmitting the user request to the target storage device; and
processing the target file according to the user request.

2. The method according to claim 1, further comprising:
calculating idle time of the target storage device; and
storing the target file and turning off the target storage device when the idle time is equal to a predetermined time duration.

3. The method according to claim 2, wherein the idle time is calculated when the target storage device receives the user request using a timer of the electronic device, and the timer is reset when the target storage device receives a next user request, or stops working when the idle time is equal to the predetermined time duration.

4. The method according to claim 1, further comprising:
determining whether file information of the target file has been updated; and
updating the directory index when the file information of the target file has been updated.

5. The method according to claim 1, further comprising:
outputting a prompt message to indicate that the target file is not stored in the plurality of storage devices, when the directory index does not comprise the information of the target file.

6. The method according to claim 1, wherein each of the plurality of storage devices is connected to a power supply or a switch.

7. An electronic device comprising:
at least one processor; and
a plurality of storage devices storing files and a plurality of instructions, which when executed by the processor, causes the at least one processor to:
establish a directory index of the files in the plurality of storage devices;
turn off the plurality of storage devices;
in response to receiving a user request for processing a target file, determine whether the directory index comprises information of the target file;
determine a target storage device that stores the target file when the directory index comprises the information of the target file;
turn on the target storage device, and transmit the user request to the target storage device; and
process the target file according to the user request.

8. The electronic device according to claim 7, wherein the at least one processor further:
calculate idle time of the target storage device; and
store the target file and turn off the target storage device when the idle time is equal to a predetermined time duration.

9. The electronic device according to claim 8, wherein the idle time is calculated when the target storage device receives the user request using a timer of the electronic device, and the timer is reset when the target storage device receives a next user request, or stops working when the idle time is equal to the predetermined time duration.

10. The electronic device according to claim 7, wherein the at least one processor further:
determining whether file information of the target file has been updated; and
updating the directory index when the file information of the target file has been updated.

11. The electronic device according to claim 7, wherein the at least one processor further:
output a prompt message to indicate that the target file is not stored in the plurality of storage devices, when the directory index does not comprise the information of the target file.

12. The electronic device according to claim 7, wherein each of the plurality of storage devices is connected to a power supply or a switch.

13. A non-transitory storage medium having stored thereon instructions that, when executed by a processor of an electronic device, causes the electronic device to perform a method for reducing energy consumption of a plurality of storage devices in the electronic device, the method comprising:
establishing a directory index of files stored in the plurality of storage devices;
turning off the plurality of storage devices using the processor;
in response to receiving a user request for processing a target file, determining whether the directory index comprises information of the target file;
determining a target storage device that stores the target file when the directory index comprises the information of the target file;
turning on the target storage device, and transmitting the user request to the target storage device; and
processing the target file according to the user request.

14. The non-transitory storage medium according to claim 13, wherein the method further comprises:
calculating idle time of the target storage device; and
storing the target file and turning off the target storage device when the idle time is equal to a predetermined time duration.

15. The non-transitory storage medium according to claim 14, wherein the idle time is calculated when the target storage device receives the user request using a timer of the electronic device, and the timer is reset when the target storage device receives a next user request, or stops working when the idle time is equal to the predetermined time duration.

16. The non-transitory storage medium according to claim 13, wherein the method further comprises:
determining whether file information of the target file has been updated; and
updating the directory index when the file information of the target file has been updated.

17. The non-transitory storage medium according to claim 13, wherein the method further comprises:
outputting a prompt message to indicate that the target file is not stored in the plurality of storage devices, when the directory index does not comprise the information of the target file.

18. The non-transitory storage medium according to claim 13, wherein each of the plurality of storage devices is connected to a power supply or a switch.
